(19) United States
(12) Patent Application Publication
(10) Pub. No.: US 2025/0172705 A1
(43) Pub. Date: May 29, 2025

(54) PLASTIC SCINTILLATORS DISCRIMINATING ALPHA-RAYS FROM BETA RAYS EMITTED BY A RADIOACTIVE MEDIUM AND METHOD FOR DISCRIMINATING ALPHA-RAYS FROM BETA-RAYS USING SAID SCINTILLATORS

(71) Applicants: COMMISSARIAT A L'ENERGIE ATOMIQUE ET AUX ENERGIES ALTERNATIVES, Paris (FR); SOFISKI UNIVERSITET SVETI KLIMENT OHRIDSKI, Sofia (BG)

(72) Inventors: Matthieu HAMEL, Gif-Sur-Yvette Cedex (FR); Romuald WOO, Gif-Sur-Yvette Cedex (FR); Benoît SABOT, Gif-Sur-Yvette Cedex (FR); Krasimir MITEV, Sofia (BG)

(73) Assignees: COMMISSARIAT A L'ENERGIE ATOMIQUE ET AUX ENERGIES ALTERNATIVES, Paris (FR); SOFISKI UNIVERSITET SVETI KLIMENT OHRIDSKI, Sofia (BG)

(21) Appl. No.: 18/842,647

(22) PCT Filed: Feb. 28, 2023
(86) PCT No.: PCT/FR2023/050273

§ 371 Date: Aug. 29, 2024

(30) Foreign Application Priority Data
Mar. 1, 2022 (FR) FR2201788

(51) Int. Cl. G01T 1/203; B33Y 80/00

(52) U.S. Cl. CPC G01T 1/203; B33Y 80/00

(57) ABSTRACT

A plastic scintillator discriminating alpha-rays from beta-rays emitted by a radioactive medium, the plastic scintillator including a plastic scintillator material capable of discriminating an alpha radiation from a beta radiation by a shape of a scintillation pulse that the alpha and the beta radiations create, having a ratio of a surface S able to be in contact with the radioactive medium to a total volume V of the plastic scintillator (S/V) greater than or equal to 7 cm⁻¹ and the surface S able to be in contact with the radioactive medium greater than or equal to 10 cm². A method of preparing the plastic scintillator, including: shaping the plastic scintillation material into a monolith; and machining, cutting the monolith into a final shape of the plastic scintillator. A detection device, including: the plastic scintillator; and a display device enabling an operator to read a level of ambient radioactivity.

### TECHNICAL FIELD

The invention relates to a plastic scintillator or scintillation detector which discriminates alpha-rays from beta-rays emitted by a radioactive medium.

It should be understood that if the plastic scintillator is only exposed to alpha-rays then it allows detecting only the alpha-rays, and gives an “alpha response”.

Similarly, it should be understood that if the plastic scintillator is only exposed to beta-rays then it allows detecting only the beta-rays, and gives a “beta response”.

Finally, if the plastic scintillator is exposed to both alpha- and beta-rays, then it allows separately detecting the two rays and gives a separate response for these two rays.

The radioactive medium may be a gaseous medium or a liquid medium containing one or more alpha-rays emitter(s) and/or one or more beta-rays emitter(s) and/or one or more mixed alpha- and beta-rays emitter(s) such as Radon-222, and possibly also one or more gamma-rays emitter(s) such as those derived from natural radioactivity.

In particular, the gaseous or liquid medium may be water or an aqueous solution such as seawater or brackish water.

These emitters may be in the form of a radioactive gas or a radioactive aerosol, for example, with the elements issued from the descendants of the radon, the alpha emitters.

We should point out that, by “aerosol”, it should be understood a medium comprising particles suspended in a gas such as air, these particles being solid and/or liquid particles, generally having a negligible drop speed.

A plastic scintillator or scintillation detector comprises a plastic scintillator material- or scintillation material-, namely a material comprising a polymeric matrix in which at least one fluorescent compound is incorporated.

The invention further relates to a method for discriminating alpha-rays from beta-rays emitted by a radioactive medium using these scintillators.

It should be noted that, throughout the present description, by “plastic scintillator” or “scintillation detector”, it should be understood a device comprising a scintillator material set in a shape suitable for use thereof.

In general, the technical field of the invention may be defined as that of nuclear instrumentation, in particular that of the detection of ionising radiations, such as the ionising radiations emitted by a medium in a gaseous form or in an aerosol form.

More specifically, the technical field of the invention may be defined as that of selective detection of alpha radiations or particles with respect to beta radiations.

The invention finds particular application in the detection of Radon (²²²Rn) which could be in a gaseous radioactive medium such as air or a liquid radioactive medium such as water.

Radon (²²²Rn) is a radioactive gas of natural origin. In France, in particular, it is the second cause of lung cancers after smoking. Its quantification has recently been added to the diagnosis on the state of the “risk” factors and information on the soils (ESRIS). The European Directive 2013/59/Euratom has reduced the detection reference threshold from 400 to 300 Bq/m³. In buildings open to the public, its control is mandatory every 10 years. Due to its partially granite geology, France is particularly concerned at the forefront by this European directive.

### Prior Art

Among the techniques for detecting radioactive gases or aerosols, one should at first distinguish between the so-called “continuous” techniques and the so-called “integrated” techniques.

The continuous techniques implement a prolonged exposure of the sensor to the radioactive gas to enable an accumulation of the interaction. The response of the sensor is then read after a determined exposure time, which prohibits any real-time determination of the volume activity of the desired gas. In other words, in continuous techniques, the measurement, such as liquid scintillation, is performed in the laboratory and not in the space to be analysed.

On the contrary, the integrated techniques may be deployed directly in the space to be analysed.

There are many “integrated” techniques for the real-time detection of radioactive gases or aerosols. In general, these techniques use passive detectors, trace detectors, for the identification of the presence or absence of these radioactive gases or aerosols, or active detectors for measuring the volume activity in the air.

These active detectors are based on different principles. These may consist of silicon semiconductor detectors, proportional counters using a carrier gas (Argon-methane) and a purification system, wire chambers for measurement in air, detectors by gamma spectrometry (encapsulated semi-conductors or scintillators), and finally detectors with a bubbling-type sampling and an offset measurement in the laboratory.

Most of these integrated techniques uses counting of ionising particles, i.e. a radiation/matter interaction is numerically counted by impact.

Therefore, these techniques do not allow having access to the information relating to the energy of the particle, not even to its nature.

This is particularly penalising in the case of Radon (²²²Rn), because the disintegration scheme of ²²²Rn is complex and gives rise to numerous descendants, some of which have close disintegration properties and which could be confused with that of radon.

Indeed, reading FIG. 1 shows that, in a closed system, and after about four hours, radon is in equilibrium with the following radionuclides: ²¹⁸Po and ²¹⁴Po which are alpha emitters (such as ²²²Rn) and ²¹⁴Pb and ²¹⁴Bi which are beta emitters.

Some devices use alpha spectroscopy, therefore energy recognition, but this technique has a low detection sensitivity and therefore does not allow achieving low volume activities within a reasonable measurement time.

Hence, if it is desired to access a spectrometric information (in other words an information relating to the energy, and therefore to the nature of the ionising radiation), two other problems appear:
(1) it is necessary to be able to distinguish by some method whether this is a radiation/matter interaction originating from an alpha emitter or from a beta emitter;
(2) it is also necessary to be able to differentiate radiation/matter interactions of the same family, in other words between two or more alpha emitters of different energy and/or between two or more beta emitters of different energy.

Hence, it has seemed that it would be relevant, in particular in the context of radon detection, to have sensors enabling discrimination between particles, in particular between the particles that constitute the alpha radiation and the particles that constitute the beta radiation.

Discrimination between particles may be carried out thanks to scintillator materials, i.e. materials that have the property of emitting light when they are subjected to ionising radiations.

These scintillator materials have photophysical properties that allow carrying out the discrimination of the particles. More specifically, it is by pulse shape discrimination (or “PSD”) that the separation of the signals is carried out.

Currently, the scintillator material may be selected either from among monocrystalline organic scintillator materials (for example, trans-stilbene), or from among plastic scintillator materials.

The plastic scintillator materials comprise fluorescent molecules fixed in an organic polymer containing only non-metal atoms, for example carbon, hydrogen, nitrogen, oxygen and sulphur. The plastic scintillator materials have “PSD” properties.

Yet, a last problem arises concerning more particularly the detection of the alpha and beta emitters.

Indeed, the difficulty of the detection of the alpha and beta emitters lies, inter alia, in the weak path in the material of the alpha and beta radiations, unlike, for example, neutrons and gamma radiation.

In particular, the alpha radiation emitted by ²²²Rn has a path in the range of 50 mm in air, and only a few tens of micrometres in water.

Hence, the interaction with the sensors, such as plastic scintillators, could be likened to a purely surface interaction, which is the case for radioactive aerosols but not necessarily for gases. For example, the radon could diffuse into the material but this diffusion is very slow.

Hence, this low path leads to a very limited interaction between the alpha or beta radiation and the material of the sensor, such as a plastic scintillator material, which makes the detection of the alpha and beta emitters very difficult.

In general, known plastic scintillators have a large-sized cylinder shape.

Since the interaction of the scintillator with the alpha and beta radiations is weakly penetrative (i.e. the distance of penetration of the radiations into the scintillator is low), a large-sized cylindrical scintillator, with regards to the penetration distance, is unsuitable for two reasons:
a large volume of the scintillator is not exposed to the alpha and beta radiations, and therefore is useless.
in contrast, this large scintillator volume proves to be sensitive to gamma-rays, in particular, which originate from natural radioactivity. Hence, this response to the background noise of the gamma-rays generates a decrease in the detection limit.

This is in particular the case of radioactive aerosols and gases in air, and even more of radioactive aerosols and gases in water.

Hence, there is a need for a plastic scintillator allowing improving the very limited interaction between the alpha or beta radiation emitted by a radioactive medium and the material of the plastic scintillator, and thus ensuring detection of these radiations which is sensitive and selective.

In particular, there is a need for a metrology of the activity for the accurate, reliable and real-time determination of radon activity in air.

### DISCLOSURE OF THE INVENTION

This aim, and still others, are achieved, in accordance with the invention by a plastic scintillator discriminating alpha-rays from beta-rays emitted by a radioactive medium, said plastic scintillator being constituted by a plastic scintillator material capable of discriminating an alpha radiation from a beta radiation by the shape of the scintillation pulse that these radiations create, characterised in that it has a ratio of the surface S liable to be in contact with the radioactive medium to the total volume V of the scintillator (S/V) greater than or equal to 7 cm⁻¹, preferably greater than or equal to 8 cm⁻¹, and a surface S liable to be in contact with the radioactive medium greater than or equal to 10 cm², preferably greater than or equal to 50 cm².

As has already been specified hereinabove, it should be understood that if the plastic scintillator is only exposed to alpha-rays, then it allows detecting only alpha-rays, and gives an “alpha response”.

Similarly, it should be understood that if the plastic scintillator is only exposed to beta-rays, then it allows detecting only the beta-rays, and gives a “beta response”.

Finally, if the plastic scintillator is exposed to both alpha- and beta-rays, then it allows separately detecting the two rays and gives a separate response for these two rays.

In the present invention, the terms ray and radiation are sometimes used indiscriminately.

The plastic scintillator according to the invention has never been described in the prior art and comprises a combination of three features which have never been described in the prior art.

According to a first essential feature of the plastic scintillator according to the invention, the latter comprises a specific plastic scintillator material capable of discriminating an alpha radiation from a beta radiation by the shape of the scintillation pulse they create, in other words having “PSD” properties, with regards to these two radiations.

Plastic scintillator materials having “PSD” properties are materials well-known to a person skilled in the art and have already been defined hereinabove. A person skilled in the art can easily determine which are plastic scintillator materials, having “PSD” properties capable of discriminating an alpha radiation from a beta radiation by their pulse shape (by the shape of the scintillation pulse they create).

Such plastic scintillator materials are described in particular in the documents WO-A1-2014/135640 and WO-A2-2012/142365 to the description of which reference could be made.

The photophysical features of the plastic scintillator material are those of a plastic scintillator material discriminating by pulse shape.

Advantageously, the plastic scintillator material may have a photoluminescence emission wavelength, which is in the visible spectrum, namely from 360 nm to 650 nm, preferably from 380 nm to 450 nm.

Advantageously, the plastic scintillator material may have a scintillation decay constant for the singlet states from 0.5 ns to 300 ns, preferably from 1 ns to 100 ns, still preferably from 1 ns to 20 ns.

Advantageously, the plastic scintillator material may have a scintillation yield from 100 to 20,000 ph/MeV, preferably from 5,000 to 15,000 ph/MeV, still preferably from 7,000 to 11,000 ph/MeV.

Advantageously, the plastic scintillator material is capable of separating the signal due to the alpha radiations of the signal due to the beta radiation emitted by the radioactive medium by their resulting pulse shape with a figure of merit value (referred to more simply as alpha/beta figure of merit (Fdm)) greater than 1, preferably greater than 1.2, more preferably greater than 1.5 (unitless) at 600 keVee (“kilo electron Volts electron equivalent”).

This 600 keVee value is the value of the abscissa at which this value of Fdm is calculated.

Thus, the plastic scintillator material which constitutes the scintillator according to the invention may comprise a matrix made of an organic polymer (for example linear or branched) or of a crosslinked organic polymer, in which at least one fluorescent compound, so-called first fluorescent compound or primary fluorophore, is incorporated.

By “organic polymer”, it should be understood a polymer comprising only non-metal atoms (for example comprising only atoms selected from among carbon, hydrogen, nitrogen, oxygen and sulphur atoms).

Similarly, the crosslinked organic polymer is a polymer comprising only non-metal atoms (for example comprising only atoms selected from among carbon, hydrogen, nitrogen, oxygen and sulphur atoms).

Advantageously, the organic polymer is liable to be obtained by polymerisation of an aromatic monomer, and the crosslinked organic polymer is liable to be obtained by polymerisation of a mixture comprising an aromatic monomer and a monomer acting as a crosslinking agent.

Advantageously, the aromatic monomer may be selected from among styrene; styrenes substituted by one or more alkyl group(s) such as t-butylstyrene and its isomers, vinyltoluene and its isomers, and vinylxylene and its isomers; vinylnaphthalene possibly substituted by one or more alkyl group(s); N-vinylcarbazole; and mixtures thereof; and the monomer acting as a crosslinking agent may be selected from among alkyl diacrylates, alkyl dimethacrylates, such as 1,4-butanediyl dimethacrylate, divinylbenzene, and mixtures thereof.

In the present invention, when mention is made of an alkyl group and, unless specified otherwise, it should generally be understood a linear or branched alkyl group generally with 1 to 20C, preferably 1 to 10C, still preferably 2 to 6C, better still 2 to 4C such as a methyl, ethyl, isopropyl, n-propyl, n-butyl, isobutyl or tert-butyl group; or a cyclic alkyl group generally with 3 to 10C, preferably 3 to 6C such as a cyclopropyl, cyclobutyl, cyclopentyl, or cyclohexyl group.

By “aromatic monomer”, it should hereby be generally understood a monomer comprising at least one aromatic ring, and also a polymerisable group.

Said polymerisable group is generally selected from among the groups comprising an ethylenically unsaturated carbon-carbon double bond such as the vinyl group.

In general, said at least one fluorescent compound is an organic compound.

Preferably, said at least one fluorescent compound is incorporated at a concentration from 10% to 30% by mass of the total mass of the plastic scintillator material.

The plastic scintillator material may comprise one or more first fluorescent compound(s) or primary fluorophore(s), possibly also a second fluorescent compound, and possibly also a third fluorescent compound.

Hence, the plastic scintillator material may comprise only one fluorescent compound (primary fluorophore), or two fluorescent compounds or three fluorescent compounds and even more.

Advantageously, the first fluorescent compound may be selected from among biphenyl, 2,5-diphenyloxazole and the substituted derivatives thereof, the fluorescent compounds of the oxadiazoles family, the molecules having intrinsic properties of generating triplet states under dense ionising radiation and their triplet-triplet annihilation, meta-terphenyl, ortho-terphenyl, para-terphenyl, and mixtures thereof; the second fluorescent compound may be selected from among bis-methyl styrylbenzene (bis-MSB), 1,4-di-[2-(5-phenyloxazolyl)]benzene (POPOP), 9,10-diphenylanthracene, 4-ethoxy-N-(2′,5′-di-t-butylphenyl)-1,8-naphthalimide, and 3-hydroxyflavone; and the third fluorescent compound may be selected from among perylene, 4-butylamino-N-(2′,5′-di-t-butylphenyl)-1,8-naphtalimide, and the compounds of the coumarins family, for example the 1, 6, 30, 102, 151, 314, 343 coumarins and “acridine yellow”.

According to a second essential feature of the plastic scintillator according to the invention, the latter has a ratio of the surface S liable to be in contact with the radioactive medium to the total volume V of the scintillator (S/V) greater than or equal to 7 cm⁻¹, preferably greater than or equal to 8 cm⁻¹.

By surface S of the scintillator liable to be in contact with the radioactive medium, or surface S potentially in contact with the radioactive medium, it should be understood the surface which, during the actual implementation of the scintillator in a radioactive medium, is in contact with the radioactive medium, is exposed to this radioactive medium. The surface S may also be called more simply the active surface.

According to the invention, the S/V has a specific value which maximises the radiation/matter interaction and ensures an efficient signal processing.

According to a third fundamental essential feature of the plastic scintillator according to the invention, the latter has a surface S liable to be in contact with the radioactive medium greater than or equal to 10 cm², preferably greater than or equal to 50 cm².

Indeed, it has been demonstrated that below this value of the active surface S, the radiation/matter interaction is quantitatively not sufficient to enable an effective signal processing with regards to the normative detection threshold even though the S/V ratio is greater than or equal to 7 cm⁻¹. This detection threshold has been established for Rn-222 at 100 Bq/m³ by the WHO (World Health Organisation, and at 300 Bq/m³ in France by the IRSN (Institut de Radioprotection et Sureté Nucléaire).

The value of the active surface S of the plastic scintillator according to the invention ensures a detection which is sufficient to meet the detection standards.

Surprisingly, according to the invention, it has been demonstrated that a plastic scintillator combining the three fundamental and essential features described hereinabove would enable a detection of the alpha and beta radiations that is sensitive and selective at the same time.

A detection combining sensitivity and selectivity is not obtained if the plastic scintillator does not have all of these three fundamental and essential features.

In other words, a plastic scintillator, made of a material having “PSD” properties, which is in a volume form-defined by specific values of S and S/V-enabling access to large surfaces, ensures a detection that is both sensitive and selective.

These two criteria regarding detection are not met without the combination of these three features.

The invention further relates to a method for preparing the plastic scintillator as described hereinabove.

According to a first embodiment of the method for preparing the plastic scintillator according to the invention, the plastic scintillator material is firstly shaped as a monolith (which has not the values of S and S/V of the plastic scintillator according to the invention), then said monolith is machined, cut to the final shape of the plastic scintillator according to the invention which has a ratio of surface S liable to be in contact with the radioactive medium/total volume V of the scintillator (S/V) greater than or equal to 7 cm⁻¹, preferably greater than or equal to 8 cm⁻¹, and a surface S liable to be in contact with the radioactive medium greater than or equal to 10 cm², preferably greater than or equal to 50 cm².

The monolith may be a parallelepiped, a cube or a cylinder, for example a right circular cylinder.

The monolith may be machined, cut by any cutting, machining technique, allowing obtaining a geometry meeting the conditions relating to the values of S and S/V of the plastic scintillator according to the invention. This cutting, machining technique may be selected from among cutting, machining techniques which implement a water cutter or a three-dimensional drill or any other mechanical tool allow achieving the desired cutting accuracy.

According to a second embodiment of the method for preparing the plastic scintillator according to the invention, the plastic scintillator material is placed, during preparation thereof, directly in the final shape of the plastic scintillator according to the invention, for example by moulding in a mould with the final shape of the scintillator according to the invention, or by 3D printing.

In this second embodiment, the shaping may therefore be performed during the preparation of the material, for example by preparing a liquid mixture of the aromatic monomer, the possible crosslinking agent (the aromatic monomer and the possible crosslinking agent, having been properly purified beforehand to remove their radical inhibitors), of the fluorescent compound(s), then by pouring this mixture into a mould in the form of the desired scintillator. Afterwards, it is proceeded with the polymerisation in the mould, generally by heating the mixture. After cooling, the scintillator thus obtained is demoulded.

Afterwards, the demoulded scintillator may be generally ground, for example by lathing, then at least one of its surfaces is polished in order to obtain a surface condition compatible with the intended applications.

The invention also relates to a detection device comprising the plastic scintillator according to the invention and a display device enabling an operator to take account of the level of ambient radioactivity by reading the number of counts per second, and possibly of the nature of a radioactivity source, for example Radon-222.

The invention also relates to a method for detecting a signal due to alpha-rays or a signal due to beta-rays or for discriminating a signal due to alpha-rays from a signal due to beta-rays, in a radiation comprising alpha- and/or beta-rays emitted by a radioactive medium, wherein the plastic scintillator according to the invention is exposed to said radioactive medium, and the signal due to alpha-rays is separated of the signal due to beta-ray by pulse shape discrimination.

In the absence of alpha-rays in the radiation, the method is capable of detecting only the signal due to beta-rays.

Similarly, in the absence of beta-rays in the radiation, the method is capable of detecting only the signal due to alpha-rays.

When the radiation comprises alpha- and/or beta-rays, the method is capable of discriminating the signal due to alpha-rays from a signal due to beta-rays.

The radioactive medium may be a gaseous radioactive medium such as air, a liquid radioactive medium such as water.

The radiation comprising alpha- and/or beta-rays may be a radiation emitted by a mixed source.

The mixed source may be Radon-222 and its radioactive descendants.

This “PSD” may be carried out, for example, either by integration of charges, or by the so-called zero-crossing technique. There are other sub-techniques for carrying out this “PSD”.

The invention will be better understood upon reading the following detailed description, in particular of particular embodiments provided in the form of examples. This detailed description is made with reference to the appended drawings.

### BRIEF DESCRIPTION OF THE DRAWINGS

FIG. 1 is a diagram which shows the disintegration of ²²²Rn, and its descendants.

FIGS. 2A, 2B and 2C show a plastic scintillator according to the invention, whose shape is generally that of a right circular cylinder, wherein the plastic scintillator material, in cross-section, is in the form of a circular spiral.

FIG. 2A is a side view of this plastic scintillator.

FIG. 2B is a cross-sectional view of this plastic scintillator according to the line A-A of FIG. 2A, at the scale 1:1.

FIG. 2C is a perspective view of this scintillator.

FIGS. 3A, 3B and 3C show a plastic scintillator according to the invention, whose shape is generally that of a right circular cylinder, wherein the plastic scintillator material is in the form of curved fins (or curved petals) arranged according to the radius of the cylinder around its centre.

FIG. 3A is a side view of this plastic scintillator.

FIG. 3B is a cross-sectional view of this plastic scintillator according to the line A-A of FIG. 3A, at the scale 1:1.

FIG. 3C is a perspective view of this scintillator.

FIGS. 4A, 4B and 4C show a plastic scintillator according to the invention, whose shape is generally that of a right circular cylinder, wherein the plastic scintillator material, in cross-section, is in the form of a plurality of elements in the form of ten-petal flowers.

FIG. 4A is a side view of this plastic scintillator.

FIG. 4B is a sectional view of this plastic scintillator according to the line A-A of FIG. 4A, at the scale 1:1.

FIG. 4C is a perspective view of this scintillator.

FIGS. 5A, 5B and 5C show a plastic scintillator according to the invention, whose shape is generally that of a right circular cylinder, wherein the plastic scintillator material which forms this cylinder is axially perforated by through orifices with a circular cross-section.

FIG. 5A is a side view of this plastic scintillator.

FIG. 5B is a sectional view of this plastic scintillator according to the line A-A of FIG. 5A, at the scale 1:1.

FIG. 5C is a perspective view of this scintillator.

FIGS. 6A, 6B and 6C show a plastic scintillator according to the invention, whose shape is generally that of a right circular cylinder, wherein the plastic scintillator material which forms this cylinder is axially perforated by through orifices with a hexagonal cross-section or honeycombs.

FIG. 6A is a side view of this plastic scintillator.

FIG. 6B is a sectional view of this plastic scintillator according to the line A-A of FIG. 6A, at the scale 1:1.

FIG. 6C is a perspective view of this scintillator.

FIGS. 7A, 7B and 7C show a plastic scintillator according to the invention, whose shape is generally that of a right circular cylinder, wherein the plastic scintillator material, in cross-section, is in the form of two spirals respectively dextrorotatory and laevorotatory.

FIG. 7A is a side view of this plastic scintillator.

FIG. 7B is a sectional view of this plastic scintillator according to the line A-A of FIG. 7A, at the scale 1:1.

FIG. 7C is a perspective view of this scintillator.

FIGS. 8A, 8B and 8C show a plastic scintillator according to the invention, whose shape is generally that of a right circular cylinder, wherein the plastic scintillator material, in cross-section, is in the form of spokes arranged according to the radius of the cylinder around its centre.

FIG. 8A is a side view of this plastic scintillator.

FIG. 8B is a sectional view of this plastic scintillator according to the line A-A of FIG. 8A, at the scale 1:1.

FIG. 8C is a perspective view of this scintillator.

FIG. 9 is a photograph of a plastic scintillator according to the invention, whose shape is generally that of a right circular cylinder, wherein the plastic scintillator material, in cross-section, is in the form of a circular spiral.

FIG. 10 is a graph which shows the figure of merit of the acquisition chain in the presence of Radon-222 in equilibrium with its descendants. The channels are plotted on the x-axis and the number of counts is plotted on the y-axis.

FIG. 11 is a graph which shows the total emission spectrum of Radon-222 in equilibrium with its descendants. The channels are plotted on the x-axis and the number of counts is plotted on the y-axis.

FIG. 12 is a graph which shows the beta emission spectrum. The channels are plotted on the x-axis and the number of counts is plotted on the y-axis.

FIG. 13 is a graph which shows the alpha emission spectrum. The channels are plotted on the x-axis and the number of counts is plotted on the y-axis.

### DETAILED DISCLOSURE OF PARTICULAR EMBODIMENTS

The plastic scintillator according to the invention consists of a specific plastic scintillator material capable of discriminating alpha radiations from beta radiations by their pulse shape, in other words, having “PSD” properties, with respect to these two radiations.

The plastic scintillator material of the scintillator according to the invention has already been described hereinabove in detail.

Plastic scintillator materials having “PSD” properties are materials that are well-known to a person skilled in the art and have already been defined hereinabove. A person skilled in the art can easily determine which are plastic scintillator materials, having “PSD” properties capable of discriminating alpha radiations from beta radiations by their pulse shape.

Such plastic scintillator materials are described in particular in the documents WO-A1-2014/135640 and WO-A2-2012/142365 to the description of which reference could be made.

In general, the plastic scintillator material comprises a matrix made of an organic polymer (which may for example be linear or branched) or of a crosslinked organic polymer, in which at least one fluorescent compound, so-called first fluorescent compound or primary fluorophore, is incorporated.

At least one molecule or fluorescent compound, generally organic, is incorporated in the polymeric matrix.

Thus, in the polymeric matrix could be incorporated:
at least one first fluorescent molecule, generally organic, whose spectral properties have different features;
possibly a second fluorescent molecule, generally organic, whose spectral properties have different features;
if the intended application requires so, possibly a third fluorescent molecule, generally organic, whose spectral properties have different features.

### Polymeric Matrix:

During the interaction between any radiation and the material, the latter should be capable of properly transferring the deposited energy.

In the case of a plastic scintillator material, the matter is none other than the polymeric matrix.

In concrete terms, the polymer of the polymeric matrix of the scintillator material may have a large number of aromatic groups which will be ionised after radiation-matter interaction.

On the path of the ion, the different molecules will be ionised and then recombinations will take place themselves giving rise to de-excitation. De-excitation will radiatively occur by emission of a fluorescence photon.

For this purpose, the organic polymer may predominantly have units derived from the polymerisation of an aromatic monomer.

Hence, the organic polymer is liable to be obtained by polymerisation of an aromatic monomer, and the crosslinked organic polymer is therefore liable to be obtained by polymerisation of a mixture comprising an aromatic monomer and a monomer acting as a crosslinking agent.

As it has already been pointed out hereinabove, by aromatic monomer, it should hereby be generally understood a monomer comprising at least one aromatic ring. This or these aromatic ring(s) may be selected from among aromatic carbon rings or heteroaromatic rings, each of these rings may comprise from 3 to 10 atoms, for example from 6 to 8 atoms. The heteroatom(s) may be selected from among N, O, P or S. For example, the aromatic monomer may be selected from among monomers comprising a benzene ring, a naphthyl group or a carbazole ring. The aromatic ring(s) may also be substituted by one or more group(s) selected from among alkyl groups.

According to the invention, this monomer further comprises a polymerisable group.

Said polymerisable group is generally selected from among the groups comprising an ethylenically unsaturated carbon-carbon double bond such as the vinyl group.

Preferably, the aromatic monomer may be selected from among styrene; styrenes substituted by one or more alkyl group(s) such as t-butylstyrene and its isomers, vinyltoluene and its isomers, and vinylxylene and its isomers; vinylnaphthalene possibly substituted by one or more alkyl group(s); N-vinylcarbazole; and mixtures thereof, and the possible monomer acting as a crosslinking agent is selected from among alkyl diacrylates, alkyl dimethacrylates, such as 1,4-butanediyl dimethacrylate, divinylbenzene and mixtures thereof.

When the polymer is prepared from one single aromatic monomer without a crosslinking agent, one could then talk about a (non-crosslinked) homopolymer.

When the polymer is prepared from several different aromatic monomers, without any crosslinking agent, one could then talk about a (non-crosslinked) copolymer.

When the polymer is prepared from one single aromatic monomer and from the crosslinking agent, one could then talk about a polymer crosslinked by the crosslinking agent.

When the polymer is prepared from several different aromatic monomers and from the crosslinking agent, one could then talk about a copolymer crosslinked by the crosslinking agent.

The crosslinking is carried out by means of molecules which could have at least two polymerisable double bonds.

According to the invention, very good results are observed when the crosslinking is carried out using, as a crosslinking agent, alkyl diacrylates meeting the following general formula (I) or alkyl dimethacrylates meeting the following general formula (II):

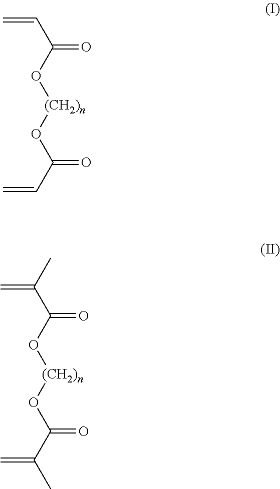

where n is an integer generally from 1 to 20, preferably from 2 to 6. n may take on all the values between 1 and 20, for example 1, 2, 3, 4, 5 or 6.

Preferably, 1,4-butanediyl dimethacrylate is used.

A range from 10% to 50% by mole of a crosslinking agent in the polymerisation mixture and a range from 90% to 50% of an aromatic monomer are particularly suitable for preparing the scintillator materials according to the invention.

Preferably, the percentage of used crosslinking agent is comprised between 15% and 20% by mole of the polymerisation mixture. In this range, the desired properties of transparency, stability, and discrimination potential are further enhanced.

The polymeric matrix should be as transparent as possible at the emission wavelength of the incorporated fluorophore(s); typically the scintillator material should be transparent at wavelengths greater than 400 nm.

A transparency gain is obtained thanks to the use of alkyl diacrylates and even more alkyl dimethacrylates which are known to be transparent in the near-UV.

Among these diacrylates and dimethacrylates, 1,4-butanediyl dimethacrylate is preferably used because of its shrinkage coefficient which is the lowest among all of the compounds that it has been possible to test.

For example, the observed density of the scintillator material according to the invention, such as the material of Example 1, is 1.08.

The possibly crosslinked polymer or copolymer of the scintillator material according to the invention may be prepared by any polymerisation process known to a person skilled in the art.

However, for the polymer to have the minimum of impurities, the polymerisation is preferably conducted by thermal initiation.

It is generally not necessary to add a radical initiator known to a person skilled in the art such as AIBN or benzoyl peroxide.

If, nonetheless, the polymerisation hardly reaches its term, it is then possible, in this case, to use a radical initiator selected for example from among the two aforementioned radical initiators, at a mass concentration generally from 0.02% to 0.2%, preferably from 0.05% to 0.1%, of the total mass of the material.

### First Fluorescent Molecule:

The at least one first fluorescent molecule (first fluorescent compound), generally organic, may be selected so as to have an absorption spectrum, whose maximum absorption intensity is between 250 nm and 350 nm, for example, this maximum absorption intensity may be centred on 300 nm.

Once excited, this molecule is then capable of emitting photons whose corresponding wavelength is between 340 nm and 400 nm, for example, whose maximum emission intensity may be centred on 360 nm.

Furthermore, since it is generally incorporated in the matrix at a high mass content, the first fluorescent molecule should advantageously have a high solubility constant in the apolar solvents.

In terms of mass concentration, a mass concentration of at least 10% by mass of this first fluorescent molecule relative to the total mass of the material, is generally used for the scintillator material to have satisfactory n/y discrimination capabilities.

Advantageously, incorporation rates comprised between 10% and 30% by mass of the total mass of the material may be used. Typically, a scintillator material composed of a polymeric matrix and a first fluorescent molecule or fluorescent compound at 16.4% by mass of the total mass of the material, constitutes an example of a scintillator material according to the invention.

The first fluorescent compound may be selected from among biphenyl, 2,5-diphenyloxazole and substituted derivatives thereof, the fluorescent compounds of the oxadiazoles family, the molecules having intrinsic properties of generating triplet states under dense ionising radiation and their triplet-triplet annihilation, meta-terphenyl ortho-terphenyl, para-terphenyl, and mixtures thereof.

In the context of the invention, it has been found that biphenyl, in particular, has all of the aforementioned features.

The para-terphenyl behaves like a “first fluorescent compound” “first fluorescent molecule” but cannot be added in a large amount due to its low solubility. On the other hand, addition thereof in a range comprised between 0.5% and 2.5% generally allows improving the discrimination.

Hence, a mixture of para-terphenyl and biphenyl could be used as the at least one first fluorescent compound.

### Second Fluorescent Molecule:

Besides the first fluorescent molecule, a second fluorescent molecule, generally organic, may be incorporated into the polymeric matrix.

The possible second fluorescent molecule may be selected so as to have an absorption spectrum able to cover the emission spectrum of the first fluorescent molecule, in particular, to optimise the energy transfers between the two fluorescent molecules, which means, in other words, that the second fluorescent molecule is able, on the one hand, to absorb photons having wavelengths belonging to the emission spectrum of said first fluorescent molecule and, on the other hand, following this absorption, to emit photons, such that the emission spectrum of said second fluorescent molecule ranges from 350 nm to 650 nm with a maximum emission intensity comprised between 400 nm and 600 nm.

The content at which the second fluorescent molecule is incorporated into the polymeric matrix is much lower than that of the first fluorescent molecule.

Typically, a concentration of the second fluorescent molecule is used comprised between 0.01% and 1% by mass of the total mass of the material, preferably from 0.01% to 0.3% by mass of the total mass of the material.

The second fluorescent compound may be selected from among bis-methyl styrylbenzene (bis-MSB), 1,4-di-[2-(5-phenyloxazolyl)] benzene (POPOP), 9,10-diphenylanthracene, 4-ethoxy-N-(2′,5′-di-t-butylphenyl)-1,8-naphthalimide, and 3-hydroxyflavone.

The preferred second fluorescent compound is POPOP.

### Third Fluorescent Molecule:

Besides the first fluorescent molecule and the second fluorescent molecule, a third fluorescent molecule, generally organic, may be incorporated into the polymeric matrix.

This third fluorescent molecule may be selected so as to have an absorption spectrum able to cover the emission spectrum of the second fluorescent molecule, in particular, to optimise the energy transfers between the two fluorescent molecules (i.e. the second and third fluorescent molecules) and improve the intrinsic efficiency of the scintillation detector.

In other words, this means that the third fluorescent molecule is able to absorb photons having wavelengths belonging to the emission spectrum of said second fluorescent molecule, said third fluorescent molecule being able, following this absorption, to emit photons, such that the emission spectrum of said third fluorescent molecule has a maximum emission intensity comprised between 500 nm and 600 nm.

The content at which the third fluorescent molecule is incorporated into the polymeric matrix is much lower than that of the first fluorescent molecule.

Typically, a concentration of the third fluorescent molecule is used from 0.001% to 0.1% by mass of the mass of the total mass of the material, preferably from 0.002% to 0.05% by mass, for example 0.005% by mass of the total mass of the material.

The third fluorescent compound is selected from among perylene, 4-butylamino-N-(2′,5′-di-t-butylphenyl)-1,8-naphthalimide, and the compounds of the coumarins family, for example the 1, 6, 30, 102, 151, 314, 343 coumarins and “acridine yellow”.

An example of a scintillator material that could constitute the scintillator according to the invention may comprise biphenyl, para-terphenyl and POPOP as fluorescent compounds into a polystyrene matrix.

From the scintillator material according to the invention, a scintillator- or scintillation detector-according to the invention is prepared by shaping the plastic scintillator material that has just been described. This scintillator should meet the conditions relating to S and S/V, set out hereinabove, which characterise the plastic scintillator according to the invention.

According to a first embodiment of the method for preparing the plastic scintillator according to the invention, the plastic scintillator material is firstly shaped as a monolith (which has not the values of S and S/V of the plastic scintillator according to the invention), then said monolith is machined, cut to the final shape of the plastic scintillator according to the invention which therefore has a ratio of surface S liable to be in contact with the radioactive medium/total volume V of the scintillator (S/V) greater than or equal to 7 cm⁻¹, preferably greater than or equal to 8 cm⁻¹, and a surface S liable to be in contact with the radioactive medium greater than or equal to 10 cm², preferably greater than or equal to 50 cm².

The monolith may be a parallelepiped, a cube or a cylinder, for example a right circular cylinder.

Afterwards, the monolith may be machined, cut by any cutting, machining technique allowing obtaining a geometry meeting the conditions relating to the values of S and S/V of the plastic scintillator according to the invention. This cutting, machining technique may be selected from among cutting, machining techniques that implement a water cutter or a three-dimensional drill or any other mechanical tool allowing achieving the desired cutting accuracy insofar as the optical quality of the material is not affected, for example by intense heating in the cutting area.

The cutting, machining technique may also be selected from among laser cutting techniques.

According to a second embodiment of the method for preparing the plastic scintillator according to the invention, the plastic scintillator material is set, during preparation thereof, directly in the final shape of the plastic scintillator according to the invention, for example by moulding in a mould with the final shape of the scintillator according to the invention, or by 3D printing.

In this second embodiment, the shaping could therefore be performed during the preparation of the material, for example by preparing a liquid mixture of the aromatic monomer, the possible crosslinking agent (the aromatic monomer and the possible crosslinking agent having been properly purified beforehand to remove their radical inhibitors), the fluorescent compound(s), then by pouring this mixture into a mould with the shape of the desired scintillator. Afterwards, it is proceeded with the polymerisation in the mould, generally by heating the mixture. After cooling, the scintillator thus obtained is demoulded.

Afterwards, the demoulded scintillator may be generally ground, for example by lathing, then at least one of its surfaces is polished in order to obtain a surface condition compatible with the intended applications.

The scintillator according to the invention may have many shapes selected so that the S/V value is greater than 7 cm⁻¹, and its volume, in accordance with the invention, is also greater than 10 cm².

Examples of these shapes are shown in FIGS. 2A, 2B, 2C, 3A, 3B, 3C, 4A, 4B, 4C, 5A, 5B, 5C, 6A, 6B, 6C, 7A, 7B, 7C, 8A, 8B, and 8C.

These examples of shape are absolutely non-limiting and the plastic scintillator according to the invention may have any shape liable to be obtained by cutting, machining, in particular by water jet, or by 3D printing or by moulding. The only limits, regarding the shape that the scintillator could have, are imposed, for example, by the resolution of the machine, the accuracy of the movement and the diameter of the water jet.

Other examples of shapes for the plastic scintillator (not shown) are those of a right circular cylinder, wherein the plastic scintillator material, in cross-section, is in the form of a plurality of elements in the form of snow flakes, or of Koch flake or of other derived fractals, like Cesaro fractal, quadratic fractals, the “sphereflake” fractal, etc.

For example, the scintillators of these figures may be prepared by firstly manufacturing a monolith made of a plastic scintillator material. For example, this monolith may be in the form of a cylinder, preferably a right circular cylinder, a parallelepiped or a cube. In the case of a cylinder with a diameter of 6 cm and a height of 1.5 cm, then the S/V ratio is to 1.33 cm⁻¹.

Afterwards, the monolith is cut, for example with a water jet to make the scintillator according to the invention having the shape show in FIGS. 2A, 2B, 2C, 3A, 3B, 3C, 4A, 4B, 4C, 5A, 5B, 5C, 6A, 6B, 6C, 7A, 7B, 7C, 8A, 8B, and 8C with an S/V ratio greater than 7 cm⁻¹.

In these figures, the solid shapes, solid volumes, constitute the plastic scintillator material and these solid shapes define empty shapes, empty volumes wherein the radioactive medium, such as a radioactive gas like air in which a mixed emitter (such as Radon-222) or a radioactive liquid such as water in which a mixed emitter is diluted can penetrate and come into contact with the surface of the plastic scintillator material.

Again, all of the exemplary shapes, shown and not shown, are absolutely non-limiting.

FIGS. 2A, 2B and 2C show a plastic scintillator according to the invention, whose shape is generally that of a right circular cylinder, wherein the plastic scintillator material, in cross-section, is in the form of a circular spiral, in other words a spiral-like wound coil. The spiral defines channels or interstices in which the radioactive medium, such as a radioactive gas like air, wherein a mixed emitter or a liquid such as water is diluted, can penetrate and come into contact with the surface of the plastic scintillator material.

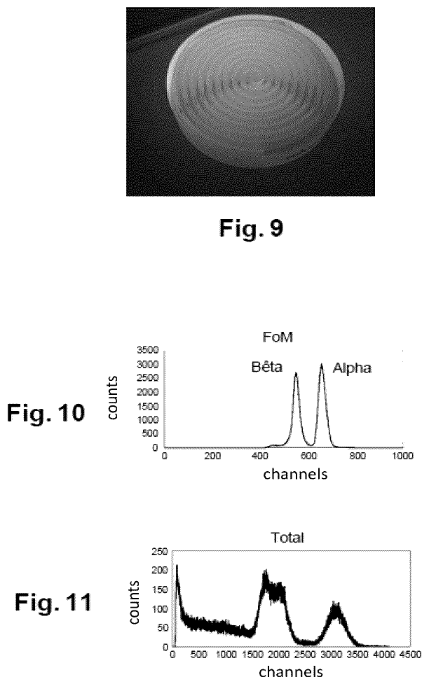

FIG. 9 is a photograph of a “spiral-like” plastic scintillator as shown in FIGS. 2A, 2B and 2C.

Table 1 gives the main features of a “spiral-like” plastic scintillator according to the invention as shown in FIGS. 2A, 2B and 2C and in FIG. 9.

TABLE 1
Main features of a “spiral-like” plastic
scintillator according to the invention.

| Features | Value range |
|---|---|
| Height (cm) | 0.1-5 |
| Diameter (cm) | 1-10 |
| Thickness of a coil (cm) | 0.01-0.5 |
| Width of an interstice (cm) | 0.01-0.1 |
| Active surface (cm²) | >=10, preferably >=50 |
| Volume (cm³) | >=1.42 |
| Surface/Volume ratio (cm⁻¹) | >=7, preferably >=8 |
| Scintillation wavelength (nm) | From 360 nm to 650 nm, preferably from |
| | 380 to 450 nm |
| Scintillation decay | From 0.5 to 300 ns, preferably from 1 to |
| constant (ns) | 100 ns, still preferably from 1 to 20 ns |
| Scintillation yield (ph/MeV) | From 1,000 to 20,000 ph/MeV, preferably |
| | from 5,000 to 15,000 ph/MeV, still |
| | preferably from 7,000 to 11,000 ph/MeV |
| Alpha/beta figure of | >1.0, preferably >1.2, still preferably >1.5 |
| merit (unitless) | |

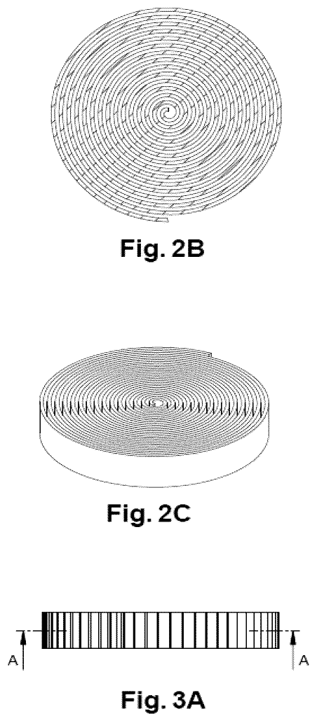

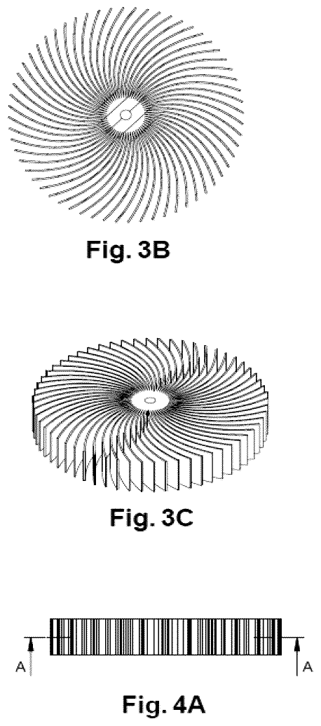

FIGS. 3A, 3B and 3C show a plastic scintillator according to the invention, whose shape is generally that of a right circular cylinder, wherein the plastic scintillator material is in the form of curved fins, curved petals, arranged according to the radius of the cylinder around its centre.

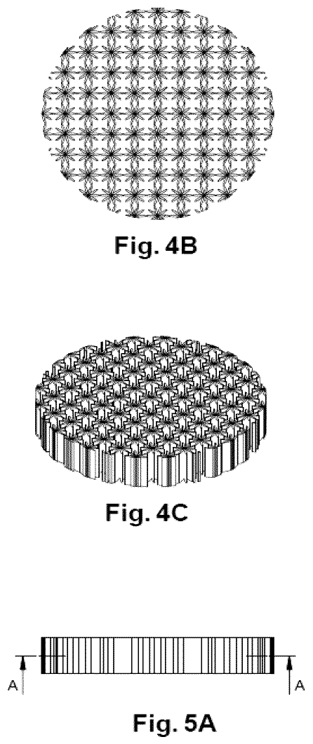

FIGS. 4A, 4B and 4C show a plastic scintillator according to the invention, whose shape is generally that of a right circular cylinder, wherein the plastic scintillator material, in cross-section, is in the form of a plurality of elements in the form of ten-petal flowers.

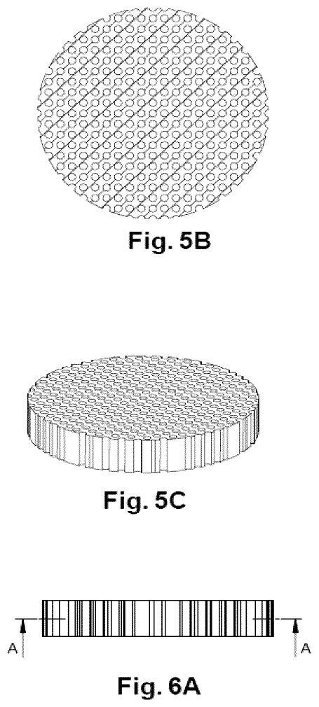

FIGS. 5A, 5B and 5C show a plastic scintillator according to the invention, whose shape is generally that of a right circular cylinder, wherein the plastic scintillator material which forms this cylinder is axially perforated by through orifices with a circular cross-section.

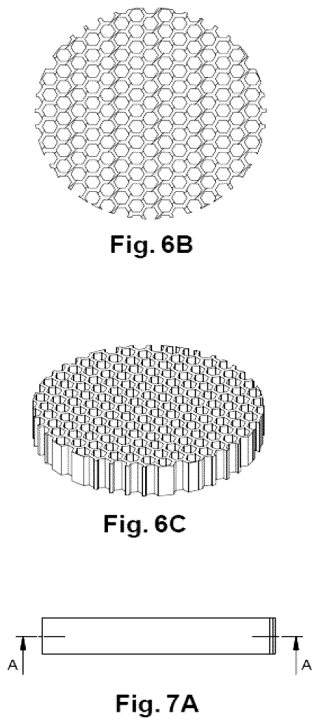

FIGS. 6A, 6B and 6C show a plastic scintillator according to the invention, whose shape is generally that of a right circular cylinder, wherein the plastic scintillator material which forms this cylinder is axially perforated by through orifices with an hexagonal cross-section or honeycombs.

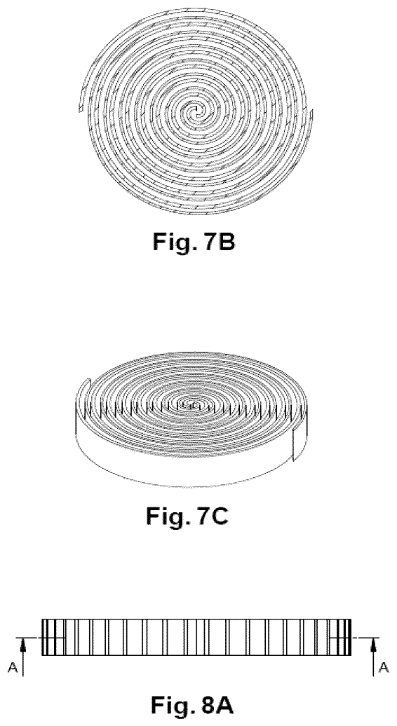

FIGS. 7A, 7B and 7C show a plastic scintillator according to the invention, whose shape is generally that of a right circular cylinder, wherein the plastic scintillator material, in cross-section, is in the form of two spirals respectively dextrorotatory and laevorotatory.

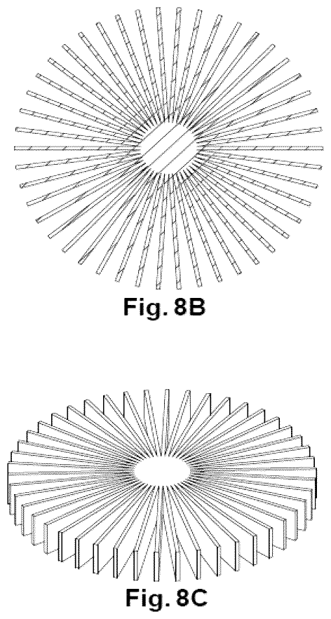

FIGS. 8A, 8B and 8C show a plastic scintillator according to the invention, whose shape is generally that of a right circular cylinder, wherein the plastic scintillator material, in cross-section, is in the form of spokes arranged according to the radius of the cylinder around its centre.

In particular, the scintillator according to the invention may be integrated into a detection device comprising the plastic scintillator according to the invention, a photon-electron converter like for example a photomultiplier tube, signal acquisition electronics and a display device displaying for example the alpha and/or beta emission count rate, and possibly the recognition of the radioactive isotope(s) having interacted with said plastic scintillator.

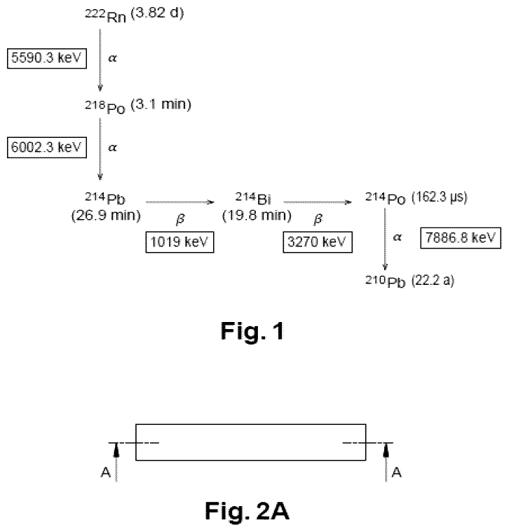

The intended applications of the scintillators according to the invention comprise in particular the detection of alpha radiations by eliminating the presence of other kinds of de-excitation, like, for example, beta or gamma de-excitations. The example of Radon-222 given in FIG. 1 shows that an accurate alpha count resulting from the decay of Radon-222 should take account of possible alpha or beta decay of the Radon-222 descendants.

When a beta radiation interacts with an organic medium, it directly ionises the scintillator and a photonic signal is recorded, arising from a so-called fast fluorescence component.

When an alpha radiation interacts with an organic medium, a high ionisation density in a small volume leads to recombination of specific excited states (triplet states), leading to a photonic signal arising from a so-called slow fluorescence component.

Hence, it is by pulse shape discrimination (or “PSD”) that the separation of the signals is carried out, more particularly herein by comparison of the slow component of the signals attributed to the beta or alpha, the beta signal generally having a slow component temporarily lower than the alpha signal.

Besides the scintillator, the system comprises one or two photomultiplier(s) (PM), which should be adapted to the emission length of the organic scintillator. Once under high voltage, the system is isolated from light to minimise the background noise. Afterwards, the signal at the output of the photomultiplier is processed in a suitable electronic chain including in particular a QDC (“Charge-to-Digital Converter”) enabling the integration of charges and the separation of signals.

The invention will now be described with reference to the following illustrative and non-limiting examples.

### EXAMPLES

In this example, a plastic scintillator according to the invention is prepared.

Pure styrene (82.2% by mass in the mixture, 136 g), biphenyl (16.4% by mass in the mixture, 27.18 g), para-terphenyl (1.2% by mass in the mixture, 2.038 g) and POPOP (0.08% by mass in the mixture, 136 mg), are mixed under an inert atmosphere in a dry vial and brought to a temperature higher than the boiling temperature of styrene. Hence, a refrigerant is adapted to this vial.

Typically, the vial used in the context of this example and which acts as a mould is a cylindrical bottle made of glass with a 250 ml capacity.

Once the mixture is partially polymerised, the vial is sealed by means of a gas-tight plug, then it is placed in an oven to complete and finish the polymerisation and obtain the plastic scintillator material.

After polymerisation, the obtained plastic scintillator material, in the form of a monolithic cylinder, is demoulded.

Afterwards, this monolithic cylinder is cut into several cylinders of smaller size.

Each of these cylinders is ground by lathing so that it has planar faces parallel to one another. Then, these faces are polished until a surface condition optically compatible with the intended applications is obtained.

Afterwards, this plastic scintillator material is cut according to the desired shape in accordance with the invention by means of a water cutter.

In this example, the plastic scintillator material is cut so as to obtain a plastic scintillator, in accordance with the invention, which is in the form of a circular spiral.

In this scintillator, the plastic scintillator material is wound so as to form a spiral-like wall or coil defining channels or interstices in which the radioactive gas can circulate.

A photograph of this spiral-like plastic scintillator is shown in FIG. 9.

The main geometric, photophysical and physical features of this spiral-like scintillator are given in table 2 hereinbelow.

TABLE 2
Main features of the spiral-like plastic scintillator
according to the invention, prepared in Example 1.

| Features | Value range |
|---|---|
| Height (cm) | 1.5 |
| Diameter (cm) | 6 |
| Thickness of a coil (cm) | 0.2 |
| Width of an interstice (cm) | 0.08 |
| Active surface (cm²) | 189.3 |
| Volume (cm³) | 21.523 |
| Surface/Volume ratio (cm⁻¹) | 8.8 |
| Scintillation wavelength (nm) | 425 |
| Scintillation decay constant (ns) | 10 |
| Scintillation yield (ph/MeV) | 8,000 |
| Alpha/beta figure of merit (unitless) | 1.50 at 600 keVee ± 80 keVee |

For the measurement, this spiral-like scintillator according to the invention is then cut again with a saw so as to have the following dimensions: length 4 mm, width 3 mm, and height 5 mm.

Afterwards, this plastic scintillator according to the invention is integrated into an experimental setup in order to show that it allows obtaining a discrimination of the signals due to alpha-rays from the signals due to beta-rays emitted by a mixed source, namely a radon ²²²Rn atmosphere (cf. FIG. 1).

In a first step, the plastic scintillator is exposed to an atmosphere of radon ²²²Rn for 240 h, then in a second step, it is left in the open air for 168 h to achieve the so-called secular balance.

Afterwards, the plastic scintillator according to the invention is integrated into an experimental setup comprising the scintillator and a photomultiplier adapted to the emission wavelength of the scintillator.

Once under high voltage, the system is isolated from light to minimise the background noise and not damage the photomultiplier.

Afterwards, the signal at the output of the photomultiplier is processed by a signal digitiser which includes in particular a “QDC” (“Charge-to-Digital Converter”) enabling the integration of the charge and the separation of the signals relating to the alpha or beta events.

It is by pulse shape discrimination (or “PSD”) that the separation of the signals is carried out, for example herein by charge integration, by comparison of the slow component of the signals assigned to the alpha-rays or to the beta-rays, the alpha signal generally having a slow component that is temporally more pronounced than the beta signal.

These signals are then sorted according to the shape of the slow component of the pulse.

In particular, this processing and the next ones are carried out with a QDC having the function of discrimination by pulse shape, such as for example the NanoPSD module of LabZY or QDC CAEN DT5730B.

These sorted pulses appear in the form of two clusters depending on the nature of the interaction (alpha or beta) as shown in FIG. 10.

In this embodiment, FIG. 10 shows the atemporal signature of the shape of the pulses (“Time-Invariant Pulse Shape spectrum” or “TIPS”). In concrete terms, the beta are sorted into the low channels (to the left) while the alpha are sorted in the high channels (to the right).

Afterwards, each cluster may be separated from the other and the associated energy spectrum could then be constructed.

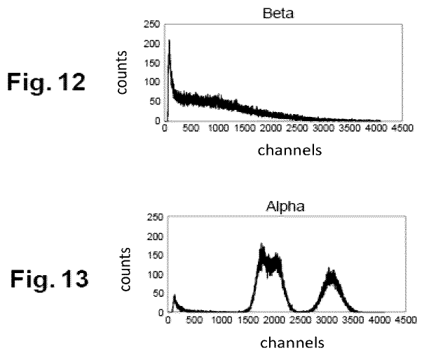

Hence, FIGS. 11 to 13 respectively show the total emission spectrum of radon in equilibrium with its descendants (FIG. 11), the beta emission spectrum due to the ²¹⁴Pb and ²¹⁴Bi emitters (FIG. 12) and the alpha emission spectrum due to the three ²²²Rn, ²¹⁸Po and ²¹⁴Po emitters. (FIG. 13).

More specifically, in FIG. 13, one could distinguish from the left to the right, the emission peak of ²²²Rn partially overlapping the peak of ²¹⁸Po (1,500-2,500 channels) and the peak of ²¹⁴Po (2,600-3,500 channels).

In view of these figures, one could notice the absence of beta signals in the alpha spectrum, and vice versa, and one could see that it is possible to separate the spectral contributions of the three alpha emitters.

From these measurements, and figures, several conclusions could be drawn:
the ability to discriminate between alpha radiations and beta radiations leads to an almost perfect spectral separation of the two types of de-excitation. There are almost no alpha in the beta spectrum and very little overlap of beta in the alpha. These beta could then be separated by analysis of regions of interest in the alpha spectrum;
the energy resolution of the studied scintillator in this example facilitates the processing of qualitative data such as the analysis of the pulse height analysis (or PHA). This PHA processing carried out after the PSD also improves the rejection of the beta radiations with regards to the alpha radiations. This energy resolution also allows defining two regions of interest in the alpha spectrum: an area comprising the contributions originating from the de-excitation of the ²²²Rn and ²¹⁸Po emitters, and a ²¹⁴Po exclusive area. When ²²²Rn is in secular equilibrium with its descendants, the comparison of these areas of interest gives information on the activity of radon and its descendants;
the separate analysis of these two areas of interest is interesting for the preferential application intended by a person skilled in the art, since ²²²Rn is in equilibrium with ²¹⁸Po after 12 min and with all its short-living descendants (in particular ²¹⁴Po) after about 4 hours. The possibility of analysing these three radionuclides independently allows accessing a real-time analysis of radon, and therefore of any other alpha/beta or alpha/gamma emitting gas or aerosol;
finally, solving the Bateman equations of these radionuclides at their secular equilibrium gives a ratio (²²²Rn+²¹⁸Po)/²¹⁴Po=1.98252;
on the other hand, the areas of interest described before give:

$${◦}^{222} Rn + {218}^{} Po = 74 , 385 counts$$

$${◦}^{214} Po = 37 , 290 counts$$

namely a Ratio: (²²²Rn+²¹⁸Po)/²¹⁴Po=1.989.

Hence, this last ratio is in perfect compliance with the ratio given hereinabove obtained from the Bateman equation.

1. A plastic scintillator discriminating alpha-ray's from beta-rays emitted by a radioactive medium, the plastic scintillator comprising:
a plastic scintillator material capable of discriminating an alpha radiation from a beta radiation by a shape of a scintillation pulse that the alpha and the beta radiations create,
wherein the plastic scintillator has a ratio of a surface S able to be in contact with the radioactive medium to a total volume V of the plastic scintillator (S/V) greater than or equal to 7 cm⁻¹, and the surface S able to be in contact with the radioactive medium greater than or equal to 10 cm².

2. The plastic scintillator of claim 1, wherein the plastic scintillator material has a photoluminescence emission wavelength from 360 nm to 650 nm.

3. The plastic scintillator of claim 1, wherein the plastic scintillator material has a scintillation decay constant for singlet states from 0.5 ns to 300 ns.

4. The plastic scintillator of claim 1, wherein the plastic scintillator material has a scintillation yield from 100 ph/MeV to 20,000 ph/MeV.

5. The plastic scintillator of claim 1, wherein the plastic scintillator material has a figure of merit greater than 1 at 600 keVee.

6. The plastic scintillator of claim 1, wherein the plastic scintillator material comprises a matrix in which at least one first fluorescent compound is incorporated, the matrix comprising an organic polymer or a crosslinked organic polymer.

7. The plastic scintillator of claim 6, wherein the organic polymer is obtained by polymerisation of an aromatic monomer, and the crosslinked organic polymer is obtained by polymerisation of a mixture comprising the aromatic monomer and a monomer which acts as a crosslinking agent.

8. The plastic scintillator of claim 7, wherein the aromatic monomer comprises at least one aromatic ring and a vinyl group.

9. The plastic scintillator of claim 7, wherein the aromatic monomer is selected from the group consisting of styrene, styrene substituted by one or more alkyl group(s), vinylnaphthalene, vinylnaphthalene substituted by one or more alkyl group(s), N-vinylcarbazole, and mixtures thereof; wherein the monomer which acts as a crosslinking agent is selected from the group consisting of alkyl diacrylate, alkyl dimethacrylate, divinylbenzene, and mixtures thereof.

10. The plastic scintillator of claim 6 wherein the plastic scintillator material further comprises a second fluorescent compound.

11. The plastic scintillator of claim 10, wherein the at least one first fluorescent compound is selected from the group consisting of biphenyl, 2,5-diphenyloxazole and substituted derivatives thereof, a fluorescent oxadiazole compound, a molecule having intrinsic properties of generating triplet states under a dense ionising radiation and their triplet-triplet annihilation, meta-terphenyl, ortho-terphenyl, para-terphenyl, and mixtures thereof; and
the second fluorescent compound is selected from the group consisting of bis-methyl styrylbenzene (bis-MSB), 1,4-di-[2-(5-phenyloxazolyl)]benzene (POPOP), 9,10-diphenylanthracene, 4-ethoxy-N-(2′,5′-di-t-butylphenyl)-1,8-naphthalimide, and 3-hydroxyflavone.

12. A method of preparing the plastic scintillator of claim 1, comprising:
shaping the plastic scintillation material into a monolith (which does not have the S and S/V values of the plastic scintillator); and
machining, cutting the monolith into a final shape of the plastic scintillator.

13. A method of preparing the plastic scintillator of claim 1, comprising:
during a preparation of the plastic scintillator material, shaping the plastic scintillator material directly into a final shape of the plastic scintillator.

14. A detection device, comprising:
the plastic scintillator of claim 1; and a display device enabling an operator to read a level of ambient radioactivity by reading a number of counts per second, and optionally a nature of a radioactivity source.

15. A method of detecting a signal due to alpha-rays or a signal due to beta-rays or of discriminating a signal due to alpha-rays from a signal due to beta-rays, in a radiation comprising alpha- and/or beta-rays emitted by a radioactive medium, the method comprising:
exposing the plastic scintillator of claim 1 to the radioactive medium; and
separating the signal due to alpha-rays from the signal due to beta-rays by pulse shape discrimination.

16. The method of claim 15, wherein the radioactive medium is a gaseous radioactive medium or a liquid radioactive medium.

17. The method of claim 15, wherein the radiation comprises alpha-rays and beta-rays emitted by a mixed source.

18. The plastic scintillator of claim 1, wherein the S/V ratio is greater than or equal to 8 cm⁻¹ and/or S is greater than or equal to 50 cm².

19. The plastic scintillator of claim 9, wherein the styrene substituted by one or more alkyl group(s) is t-butylstyrene or its isomers, vinyltoluene or its isomers, or vinylxylene or its isomers, and wherein the alkyl dimethacrylate is 1,4-butanediyl dimethacrylate.

20. The plastic scintillator of claim 10, wherein the plastic scintillator material further comprises a third fluorescent compound.

21. The plastic scintillator of claim 20, wherein the third fluorescent compound is perylene, 4-butylamino-N-(2′,5′-di-t-butylphenyl)-1,8-naphthalimide, a coumarin compound, or an acridine yellow compound.

22. The method of claim 13, wherein the shaping is carried out by moulding the plastic scintillator material in a mould into the final shape of the plastic scintillator, or by 3D printing.

23. The detection device of claim 14, wherein the radioactivity source comprises Radon-222.

24. The method of claim 17, wherein the mixed source comprises Radon-222 and its radioactive descendants.
